(19) United States
(12) Patent Application Publication
(10) Pub. No.: US 2007/0269604 A1
(43) Pub. Date: Nov. 22, 2007

(54) Method for manufacturing smooth diamond heat sinks

(76) Inventors: Daniel Francis, Oakland, CA (US); Felix Ejeckam, San Francisco, CA (US); Shabbir Bashar, Milpitas, CA (US); Dubravko Babic, San Jose, CA (US)

Correspondence Address: PILLSBURY WINTHROP SHAW PITTMAN LLP, P.O. BOX 10500, MCLEAN, VA, 22102, US

(21) Appl. No.: 11/654,359

(22) Filed: Jan. 16, 2007

Related U.S. Application Data
(60) Provisional application No. 60/758,628, filed on Jan. 13, 2006.

(51) Int. Cl. B05D 1/40

(52) U.S. Cl. 427/331

(57) ABSTRACT

A method for making diamond heat sinks where the diamond is smooth and is not bowed. Smooth diamond is created by depositing synthetic diamond onto a smooth substrate. The substrate subsequently removed revealing a diamond surface that is smooth. Bow in the diamond layers resulting from intrinsic stress can be reduced by bonding two diamond films with similar intrinsic stress with the final growth surfaces facing each other.

### RELATED APPLICATIONS

This application claims the benefit of U.S. Provisional Patent Application Ser. No. 60/758,628 filed Jan. 13, 2006.

### BACKGROUND OF THE INVENTION

1. Field of the Invention

The present invention relates to chemical vapor deposition of diamond films, diamond-like carbon, and synthetic diamond, and use of these in heat sinks.

2. Brief Description of the Prior Art

Electronic circuits and devices continue to progress towards higher power densities. This process results in increased demand for methods to conduct heat away from the devices. Heat removal is typically accomplished by placing the electronic device, optical device or integrated circuit as close as possible to a heat sink. Most often the heat sinks are copper blocks attached to a water-cooling system, aluminum fins, or a micro-channel cooler.

Such heat removal systems are typically large in comparison with the heat source in the electronic chip or individual device and the thermal performance improvement they offer is limited. This is because the heat sources are typically small and most of the temperature rise occurs in the immediate proximity of the source. A complimentary technology that addresses the temperature rise in small, confined areas is based on expanding the heat flow areas using so-called heat-spreading layers. The purpose of a heat-spreading layer is to efficiently carry heat away from small sources and spread it over larger areas where it can be more efficiently removed using large and very efficient heat sinks. Heat-spreading layers can be integrated into electronic and optoelectronic devices in a variety of ways. The essential requirements placed on the spreading materials and the integration technology are high thermal conductivity, straightforward deposition technology, and their ability to produce thermal contact with the surrounding materials and structures. Metals, such as copper and silver, which are excellent thermal conductors are also electrically conductive. In many applications requiring low parasitic capacitances and low crosstalk, it is necessary that the heat-spreading layers be insulating.

The heat spreading for efficient cooling of high-density heat sources can be done with diamond layers. The principle is illustrated with the help of FIGS. 1(a)-1(d).

In FIG. 1(a), a heat source 101 is located on top of a silicon chip 103. The chip 103 is disposed on a silicon substrate 102, which is wider than the chip 103. FIG. 1(b) shows a theoretically calculated temperature profile for an infinitely long structure (extending into paper) for which the cross-sectional view is schematically illustrated in FIG. 1(a). Since the device is symmetrical, only one half is used to calculate the temperature profile. The heat emanates from the heat source 121 (corresponding to heat source 101 in FIG. 1(a)) and is funneled directly down into the substrate 122 (substrate 122 in FIG. 1(b) corresponds to substrate 102 in FIG. 1(a)) as shown with the arrows 105. The arrows 105 indicating direction of heat flow are perpendicular to the multiplicity of “isotherms” (125 and 126), the curves that connect points with the same temperature. The density of “isotherms” along the direction perpendicular to the isotherms shows relative gradient in temperature. For chip 103 width and height equal to 0.12 mm and 0.15 mm, respectively, and substrate 102 thickness equal to 0.5 mm, the temperature rise at the heat source is calculated to be 0.3° C. for every 1 W/cm of device length.

In FIG. 1(c), the device structure shown in FIG. 1(a) is modified by adding a diamond spreading layer 114 between the silicon chip 113 and the silicon substrate 112. A heat source 111 is located on top of the silicon chip 113. The thickness of the diamond heat-spreading layer 114 is 0.1 mm, while the thickness of the silicon substrate 112 is 0.4 mm. The temperature profile calculated for the structure shown in FIG. 1(c) is shown in FIG. 1(d). It is visible in FIG. 1(d) that substantial heat flow is directed in the lateral direction through the spreading layer 114 as indicated with arrows 115 from the heat source 131 towards the substrate 132. For the device (FIG. 1(d)) with the diamond heat spreader 134, the density of isotherms in the silicon chip 135 is higher than the density of isotherms in the silicon substrate 136. The density of isotherms in the silicon chip 135 is greater than the isotherm density in the silicon chip 125. This difference indicates that a comparably smaller temperature drop has been realized in the silicon substrate 132 by the use of the diamond heat spreader 134 in respect to the temperature drop in the silicon substrate 122. The temperature rise in the heat source for every 1 W/cm of device length has been reduced to 0.2° C. This is a significant reduction (30%) in device temperature that will result in longer life and improved device performance. Diamond is the material with the highest thermal conductivity and is thus most suitable for such applications. In this case, the diamond is 0.15 mm away from the heat source, and the closer the diamond is to the heat source, the greater the effect of heat spreading.

Natural diamond is the best thermal conductor, but is not available for these applications due to scarcity and price. The alternative is the use of synthetic diamond deposited by a chemical-vapor deposition (CVD). This material has thermal conductivity similar to that of single crystal diamond. In the CVD process a substrate on top of which synthetic diamond is to be deposited is placed in a chamber and heated to temperatures close to 1000° C. Reaction gases flow into the chamber and synthetic diamond is formed on the surface of the substrate. The growth of synthetic diamond often includes a nucleation phase in which the conditions are adjusted to enhance the adhesion of the layer upon first exposure to the host substrate. During the growth, the grain size of synthetic diamond increases. As a result, there are several issues related to synthetic diamond that make it difficult in take full advantage of its high thermal conductivity: (a) CVD diamond films are inherently rough after deposition, and (b) the films exhibit intrinsic stress, which result in substrate bow. The efficiency of a heat spreader greatly depends on the quality of the thermal contact between the heat source and the heat spreader. If one of the surfaces is rough or bowed, the thermal contact is poor. The present invention provides a method of producing thermal heat sinks with CVD diamond films that are smooth and have wafer bow that satisfies the requirements of the microelectronic and optical industries needs for thermal contact.

We first discuss physical quantities related to surface quality. A surface is a boundary that separates an object from another object or substance. A surface form is the intended surface shape. For example, a silicon wafer used in the semiconductor industry has a flat surface form. A real surface deviates from the surface form due to manufacturing imperfections and external forces. For this reason, a substantial effort has been developed in the industry to characterize the mechanical imperfections of surfaces. The parameters relevant for this work are surface roughness and surface bow. We will define these in the next paragraphs.

Every real surface we will be discussing will be finite (have boundaries) and a central plane. A central plane is an imaginary plane that can be defined for any finite surface in the following way: if the distance of every point on a surface is measured relative to an arbitrary reference plane, then the central plane is obtained by linear regression of the collected two-dimensional data. Namely, the average of all of the distances between each point on the surface to the central plane equals zero. A surface profile is the set of data points indicating the distance from the surface to the central plane. The word surface profile may be used for both one-dimensional and two-dimensional profiles. Measurements performed on real surfaces are typically performed over areas that are smaller than the entire surface. For example, the surface roughness may be evaluated over a rectangular area with several micrometers on each side, while the surface (or wafer) bow may be evaluated over an area that is almost as large as the wafer (the entire surface). The area or distance over which a certain surface profile parameter is evaluated is referred to as the evaluation area.

A profiling method is a means of measuring a profile of a surface. The result of the method is a one- or two-dimensional graph of the shape of the surface over an evaluation distance or area. The most common type of profiling instrument draws a stylus across the surface and measures its vertical displacement as a function of position. In the last decade, the atomic force microscope has been used for characterizing surfaces on a nanometer scale.

We will discuss rms surface roughness A, which is defined as the square root of the variance of the surface height z(x,y)over the central plane. Here z is the distance between the surface and the central plane at a location on the central plane defined by coordinates x and y:

$${σ}^{2} = \frac{1}{A} {\int \int }_{A} {( z ( x , y ) - \overline{z} )}^{2} ⅆ x ⅆ y \overline{z} = \frac{1}{A} {\int \int }_{A} z ( x , y ) ⅆ x ⅆ y$$

Here A is the evaluation area, and z̅ is the average of the surface distance to the central plane taken on the evaluation area A. The surface bow is defined as the largest deviation in the surface profile encountered on the evaluation area A.
B=MAX[z(x,y)]|_{A}−MIN[z(x,y)]|_{A}

One of the origins of surface bow is wafer bowing due to stress introduced by a film deposited on the wafer. For example, a wafer of diameter D may be bowed with a radius of curvature equal to R. Such a wafer has a bow equal to

$$B = R \cdot ( 1 - cos ( \frac{D}{2 R} ) ) \approx \frac{{D}^{2}}{8 R}$$

In state-of-the-art thermal management applications, devices on different wafers are brought into thermal contact. In these applications, the presence of bow and surface roughness may significantly disrupt effective heat conduction.

In a typical CVD diamond process, a thin film of diamond (a few microns to thousands of microns) is grown on a substrate. Although the top surface of the substrate can be very smooth, the top surface of the grown diamond layer is rough. If the substrate is a silicon wafer, its rms surface roughness measured over a square evaluation area of 100 μm² may be less than 1 nm. At the same time, the rms surface roughness of the deposited diamond film may be as high as 10% of the grown diamond thickness. That surface roughness is generally unacceptable for most high-end thermal (and optical) contact applications, which need rms surface roughness values below 10 nm and a bow over an entire 12-inch wafer to be less than 50 μm. The only alternative the industry has had to resolve this issue is to polish the diamond layers. However, as diamond is the hardest substance known, this not an easy process and does not result in surface roughness that is close to 10 nm.

FIG. 2 illustrates the effect of intrinsic stress in diamond films deposited on a silicon substrate on a sequence of process steps. In FIG. 2(a), a free-standing silicon wafer 203 has a flat surface 202. The surface bow is less than several micrometers over the 12-inch wafer. In FIG. 2(b), a CVD diamond film 211 is deposited on the wafer 202, on its surface 202. The intrinsic stress in the diamond film 211 bows the entire structure 210. The top surface 212 of the silicon wafer 203 is now concave. If the silicon substrate 203 is removed from the diamond film 211, the diamond film 211 will exhibit a bow as shown in FIG. 2(c). The bottom surface 222 of the diamond film 211 is convex. The intrinsic stress in the diamond film is sufficient to produce an unacceptable amount of bow when deposited on a 12-inch silicon wafer. Diamond film thicknesses used in heat spreading applications typically range from 1 to 1000 μm and may result in a bow that is as large as 1 mm for thick diamond films. This prevents the wafer from being usable for chip fabrication in silicon-on-diamond wafer configurations, and prevents the efficient chip mounting and thermal contact that enable the full utilization of the diamond film heat spreading capability.

The present invention provides a method to produce heat spreaders in a more straightforward method to achieve smooth, strain-free diamond heat sinks.

### BRIEF SUMMARY OF THE INVENTION

The present invention offers an improvement over the prior art of making heat spreaders by providing a simpler, more reliable method for producing usable heat sinks from the as-grown synthetic diamond. A flat and bow-free heat spreading surface made out of synthetic diamond is made using bonding technology and silicon wafers in several preferred methods.

In the first method, a diamond film is deposited on a flat silicon substrate. The flat silicon substrate is subsequently removed in at least one area (or section), revealing a smooth diamond surface templated by the flat silicon wafer surface on which the CVD diamond film was grown.

In the second method, a diamond film is deposited on a flat silicon substrate, then the rough surface of diamond is bonded to a heat sink substrate after which the original flat silicon substrate is removed, revealing a smooth diamond surface templated by the flat silicon wafer surface on which the CVD diamond film was grown.

In the third method, there are two silicon wafers with a CVD diamond layer on one side of each wafer. The CVD diamond layers are brought in contact and glued to each other. One of the substrates is removed to reveal flat diamond where the intrinsic stress has been compensated by bonding with the other diamond layer, having the opposite bow.

In the second and third methods, the heat sink substrate may be a copper heat sink that helps conduct heat away. Other substrates that could be used include gallium arsenide, sapphire, silicon dioxide, aluminum oxide, aluminum nitride, silicon carbide, indium phosphide, zinc selenide, zinc cadmium telluride, indium gallium arsenide, or metals, such as but not exclusively, copper tungsten, aluminum, steel or cooper. The substrate is chosen based on the application's need for substrate conductivity, dielectric constant or thermal expansion coefficient.

In the second and third methods, the criteria for selecting a bonding agent include adhesion to diamond, adhesion to the carrier substrate, temperature of bonding, temperature of operation of final heat sink, and electrical/thermal conductivity of the bonding material. Candidate bonding agents include, but are not limited to, metals such as gold, copper, aluminum, tin, lead, indium, titanium, chromium, nickel, silver or combinations of the metals where metals such as titanium and chromium are used as adhesion layers. Alternative bonding agents include, but are not limited to, poly crystalline silicon, silicon nitride, silicon oxide, spin-on glass, aluminum nitride, tin oxide, or other dielectrics.

All three preferred methods may be used to form smooth layers of materials different than diamond (such as gallium nitride, sapphire, silicon carbide, etc.) on substrates other than silicon.

### IN THE DRAWINGS

FIGS. 1(a)-1(d) illustrate the principle of chip cooling improvement by adding heat spreading layers;

FIG. 2 illustrates the bowing of substrates and diamond films due to the intrinsic stress in diamond films;

FIGS. 3(a)-3(c) illustrate the process flow for the three preferred methods;

FIG. 4 illustrates the first preferred method for the manufacture of smooth diamond heat spreading layers; and

FIGS. 5(a)-5(b) are photographs of a diamond heat spreading layer manufactured according to the first preferred method

FIGS. 6(a) and (b) illustrate the second preferred method for the manufacture of smooth diamond heat spreading layers;

FIGS. 7(a)-7(h) illustrate the third preferred method of the manufacture of smooth diamond heat spreading layers;

FIGS. 8(a)-8(e) illustrate the use of the first preferred method to arbitrary thin films and substrates;

FIG. 9 illustrates placement of an electronic or optical device on a smooth diamond surface.

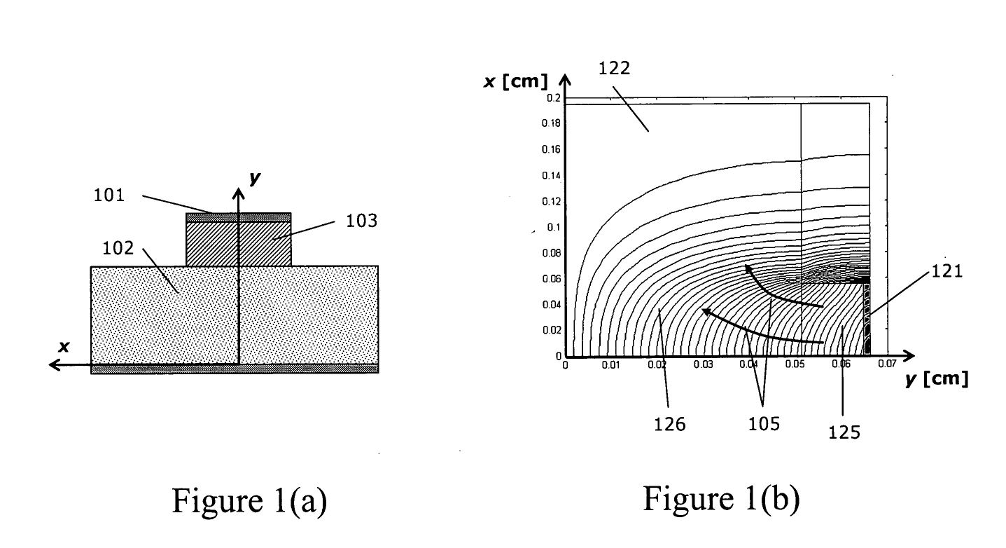

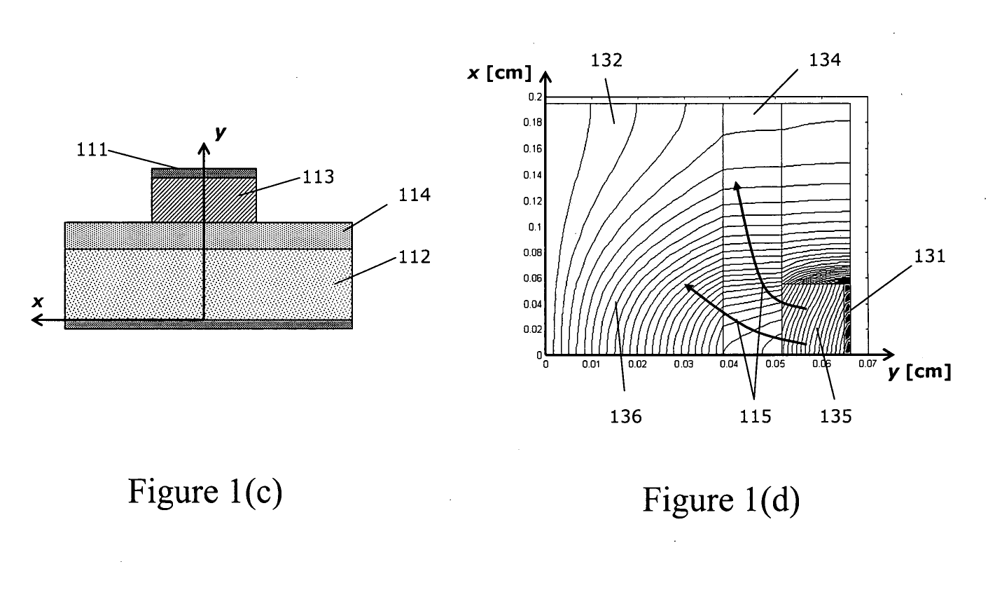

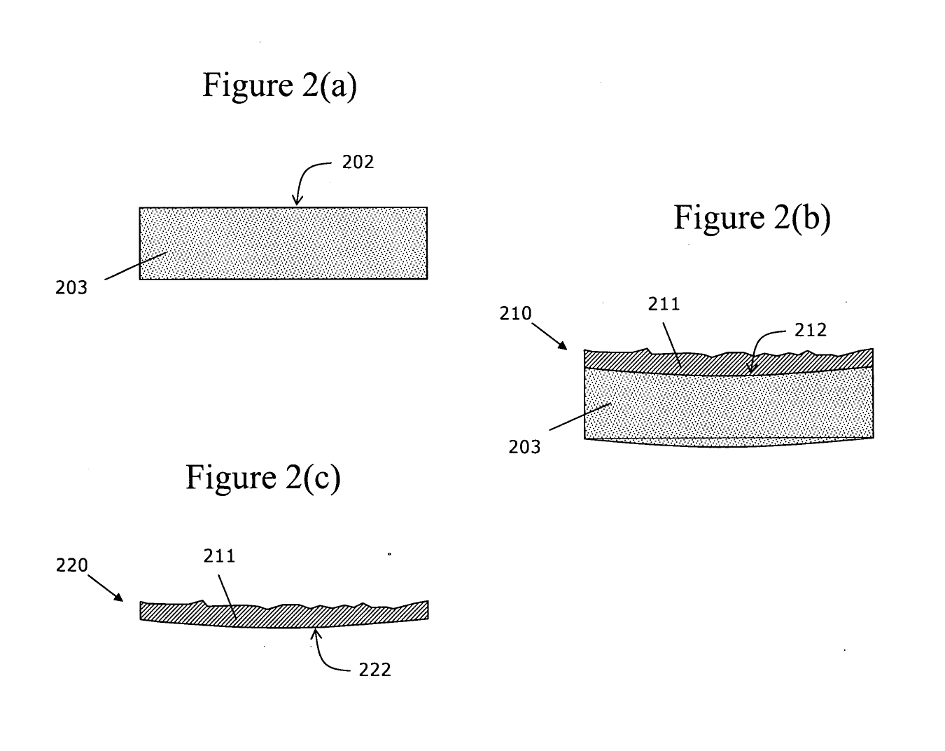

### DETAILED DESCRIPTION OF THE INVENTION

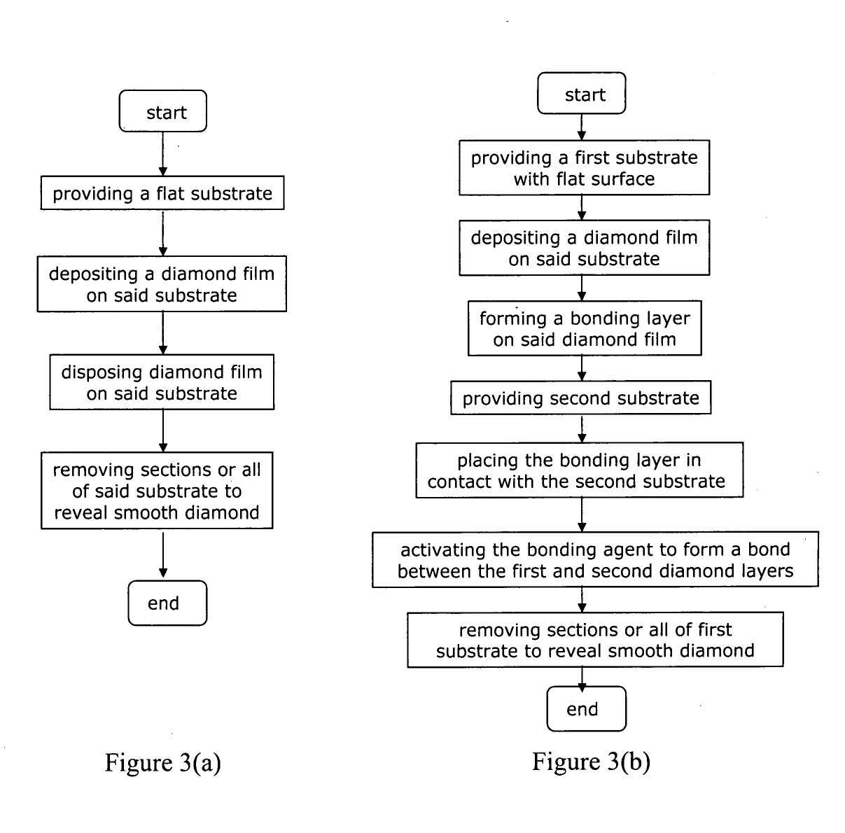

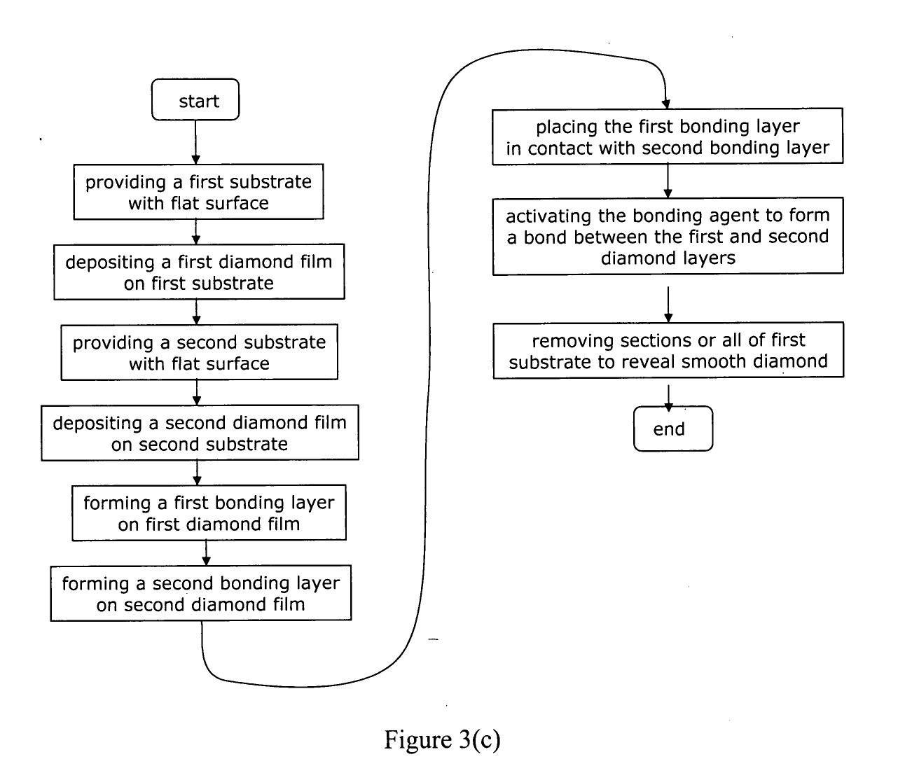

The present invention relates to a method for making diamond heat spreading layers that are smooth and have very low bow. As noted above, achieving smooth and flat diamond is important in achieving cost effective and thus useful diamond heat spreading layers. FIGS. 3(a)-3(c) are process flow charts for the three preferred embodiments of the present invention, and these processes are described in more detail below.

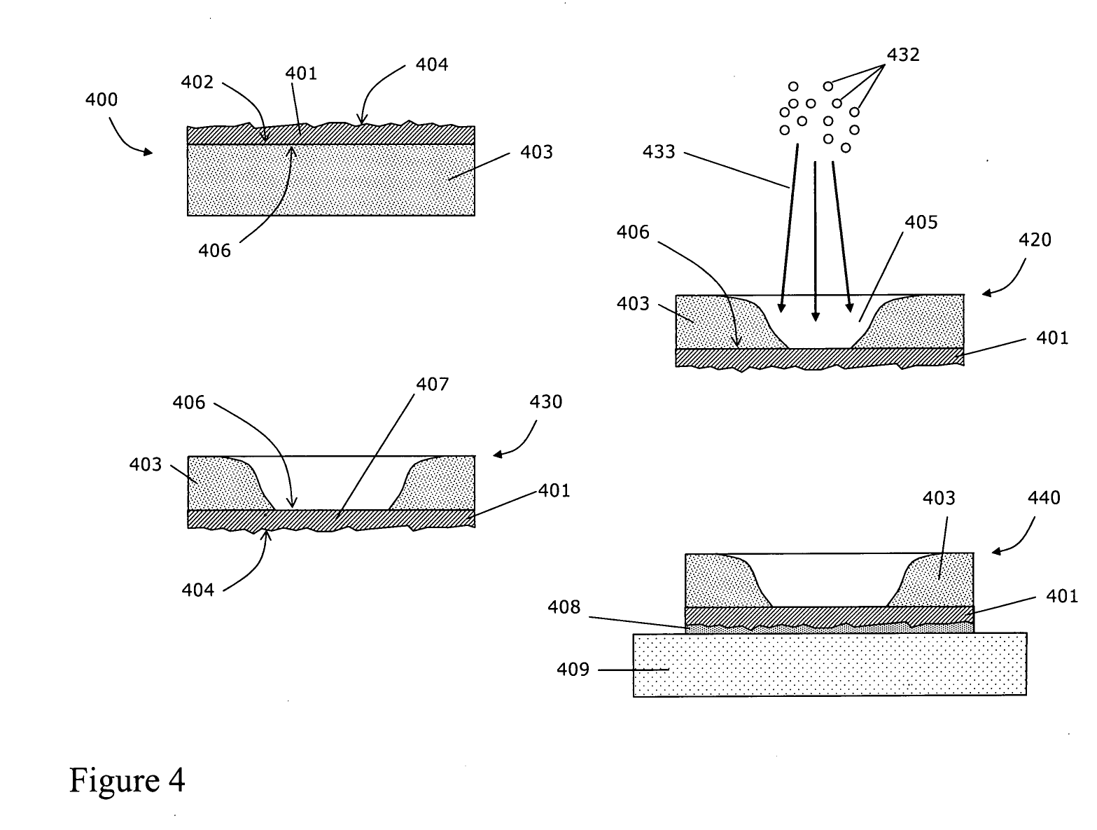

The first preferred method of this invention is schematically illustrated in FIG. 4. The process flow of the first method is also illustrated win FIG. 3(a). In step 400, a CVD diamond film 401 is deposited on the surface 402 of a substrate 403. The substrate 403 is preferably a crystalline silicon wafer, but may be any suitable material selected for its thermal, mechanical, and surface properties. Examples include silicon carbide, sapphire, or gallium arsenide. The surface 402 is smooth: It has rms surface roughness and surface bow less than 10 nm measured over an evaluation area of 100 μm², and 40 μm over 300 mm, respectively. This specification is sufficient for successful attachment of electronic and optical devices. The surface of the deposited diamond film 401 facing the substrate 403 is denoted with 406. The surface 406 conforms to the surface 402 and hence has similar surface roughness.

As a result of the deposition process, the top surface 404 of the deposited diamond film 401 has roughness that is significantly larger than that of the substrate surface 402. The roughness of the diamond top surface 404 may be as large as 10% of the total thickness of the deposited diamond film 401, and this high surface roughness is inadequate for the realization of good thermal contact between the diamond film 401 and any other smooth surface that may eventually be used to contact this structure.

In step 420, the structure shown in 400 is turned upside down and a section or sections of the substrate 403 are removed down to the diamond film 401. In the first preferred method, the substrate 403 removal is accomplished using a process commonly known as sandblasting, in which small particles 432 of an inert, solid material are blasted at the substrate 403 at high speed, as indicated with arrows 433. The particles are accelerated using pressurized gas, for example, by air or nitrogen, as is known in the art. The mechanical impact of the particles 432 on the substrate 403 effectively removes the material from the sections 405 of the substrate 403 which are exposed to the impact. The sandblasting process keeps removing material until it reaches the surface 406 of the underlying diamond layer 401. The choice of material for the sandblasting particles 432 includes, but is not limited to, alumina and silicon dioxide. The sandblasting is performed with pressures in the range between 50 kPa to 1 MPa, and the removal rate for a silicon wafer may be around 1 mm/sec. The main requirement on the choice of the sandblasting material is that it has hardness significantly lower than that of diamond. This is necessary to prevent any damage to the diamond film 401.

Hardness is one measure of the strength of the structure of a solid material (crystal or mineral) relative to the strength of its chemical bonds. Hardness can be tested through scratching. A scratch on a material is actually a groove produced by fractures on the surface of the mineral. It requires either the breaking of bonds or the displacement of atoms (as in the metallic bonded minerals). Any material can only be scratched by a harder material. A hard material can scratch a softer material, but a soft material cannot scratch a harder material. For these reasons, a relative scale has been established to account for the differences in hardness simply by seeing which material scratches another. Diamond is the hardest substance found in nature, and it four times harder than the next hardest natural material, corundum (sapphire and ruby).

After an opening 405 in the substrate 403 has been realized, the resulting structure 430 exhibits a diamond film membrane 407 stretched between remaining sections of the substrate 403. The revealed surface 406 of the diamond film 401 has approximately the same surface roughness as the original substrate surface 402. Namely, the surface 402 profile has transferred to the surface 406. The structure shown in 430 exhibits a section of smooth diamond 407. Step 440 illustrates how structure 430 is now available to be mounted on another heat sink 409 using a suitable adhesive 408.

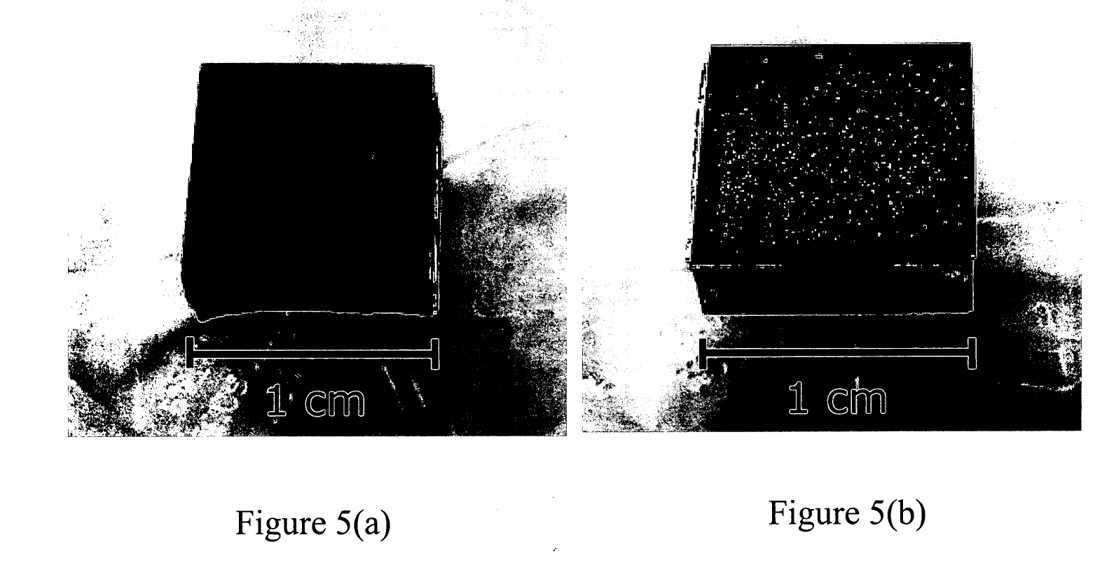

FIG. 5 shows a photograph of structure a 430 seen from above and below. In FIG. 5(a), note the opening 405 in the silicon wafer 403 revealing smooth diamond surface 406, while in FIG. 5(b), note the visibly rough surface 404 of the diamond layer 401. The diamond layer shown in FIG. 5 exhibits rms surface roughness better than 5 nm measured over an evaluation surface with area 100 um².

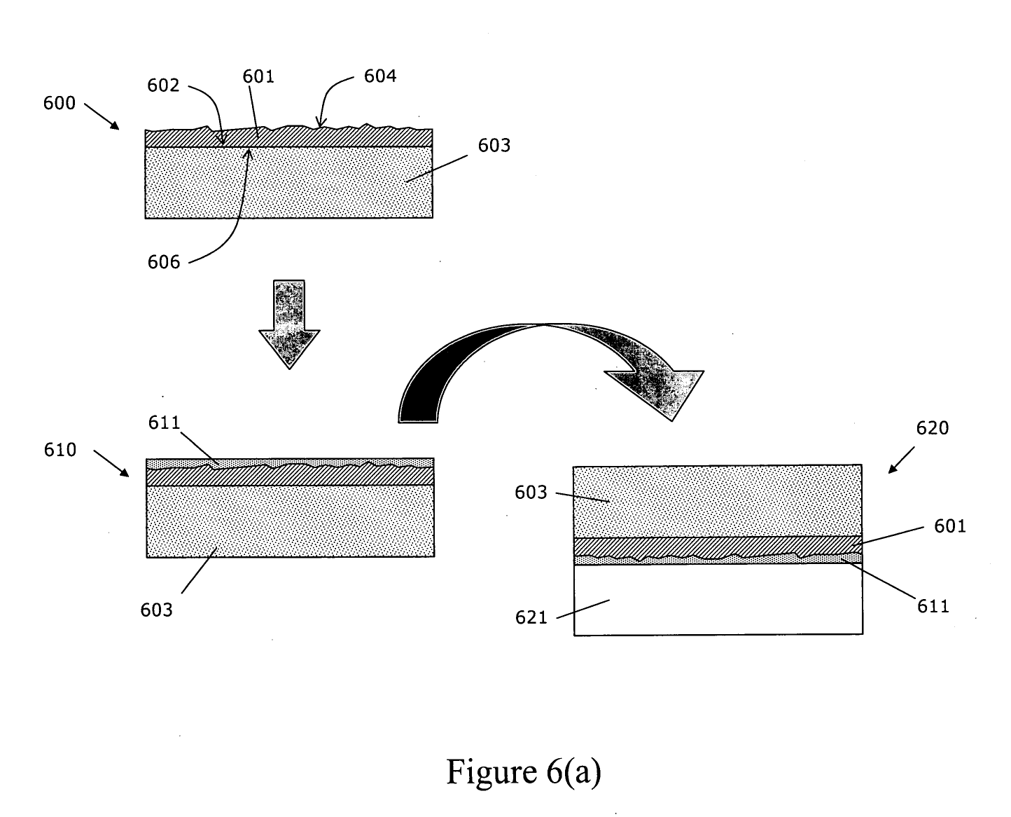

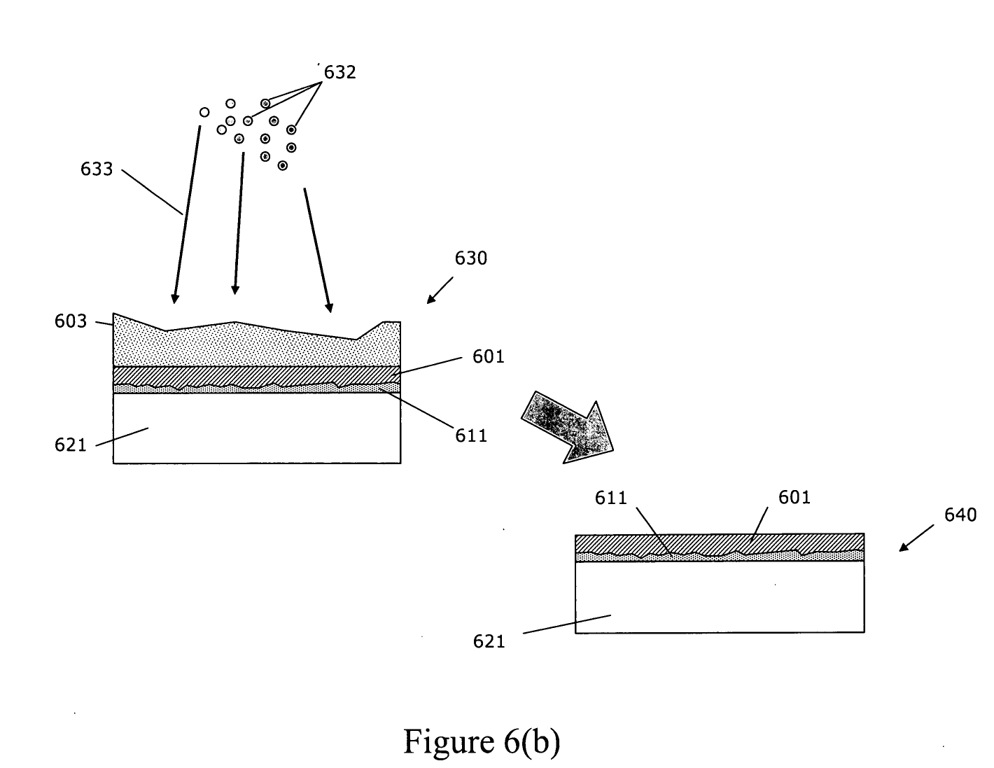

The second preferred method of manufacturing heat sinks with smooth diamond is illustrated using FIG. 6 and process flow chart shown in FIG. 3(b). In illustration 600 of FIG. 6(a), a CVD diamond film 601 is deposited on the surface 602 of a substrate 603. The substrate 603 is preferably a crystalline silicon wafer, but may be any suitable material selected for its thermal, mechanical, and/or surface properties. Examples include silicon carbide, sapphire, or gallium arsenide. The surface 602 is smooth. It has surface roughness and surface flatness specifications that are better than required for successful attachment of devices. The typical surface roughness requirement is less than 10 nm measured over an evaluation area of 100 μm², and the surface bow is less than 40 μm over 300 mm. As a result of the deposition process, the top surface 604 of the deposited diamond film 601 has roughness that is significantly larger than that of the substrate surface 602. The roughness of the diamond top surface 604 may be as large as 10% of the total thickness of the deposited diamond film 601. The surface of the deposited diamond film 601 facing the substrate 603 is denoted with 606. The surface 606 conforms to the surface 602 and hence has similar surface roughness.

In illustration 610, a surface-conforming bonding agent is deposited over the diamond film 601, forming a bonding layer 611. The bonding agent is chosen appropriately. In choosing a bonding agent, the following factors are considered: ability to adhere to diamond, ability to adhere to the carrier substrate, the bonding temperature, the temperature of operation of the final heat sink, and the electrical/thermal conductivity. Candidate bonding agents include, but are not limited to, metals such as gold, copper, aluminum, tin, lead, indium, titanium, chromium, nickel, silver or combinations of the metals, where metals such as titanium and chromium are used as adhesion layers. Alternative bonding agents include, but are not limited to, polycrystalline silicon, silicon nitride, silicon oxide, spin-on glass, aluminum nitride, tin oxide, or other dielectrics.

In illustration 620, the structure shown in 610 is turned upside down and placed on top of a heat sink substrate 621 in such a way that the bonding layer 611 is directly adjacent to the heat sink substrate 621. The bonding layer 611 is subsequently activated by heating the structure 620 to re-flow the bonding agent, if metal is used, or to cure the bonding agent, if an organic adhesion layer is used. At this point, the structure 620 exhibits a single diamond layer 601 and a bonding layer 611 sandwiched between two substrates: the flat substrate 603 and the heat sink substrate 621.

In illustration 630 shown in FIG. 6(b), the substrate 603 is removed down to the diamond film 601. The removal of the substrate 603 is accomplished by either sandblasting, by a, chemical etch, or by a combination of the two. Illustration 630 depicts sandblasting, in which small particles 632 of an inert solid material are blasted upon the substrate 603 at high speed, as indicated with arrows 633. The mechanical impact of the particles 632 on the substrate 603 effectively removes the substrate 603 material, but does not remove or damage the underlying diamond layer 601. Examples of chemical etches for silicon include mixtures of nitric and hydrofluoric acids, or potassium hydroxide, well known in the silicon semiconductor industry.

After the removal of substrate 603, the resulting structure shown in illustration 640 exhibits a single smooth diamond film 601 attached to a heat sink substrate 621. The completed structure is available for attaching various electronic and/or optoelectronic devices to its surface.

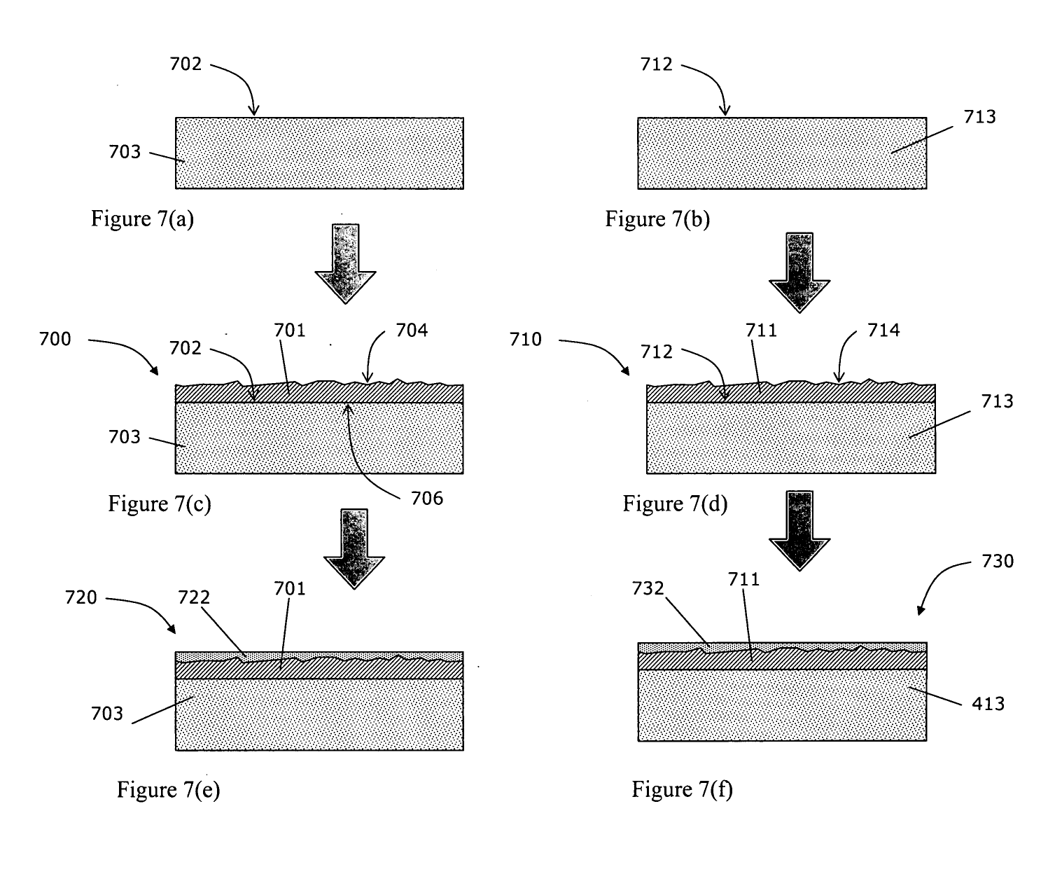

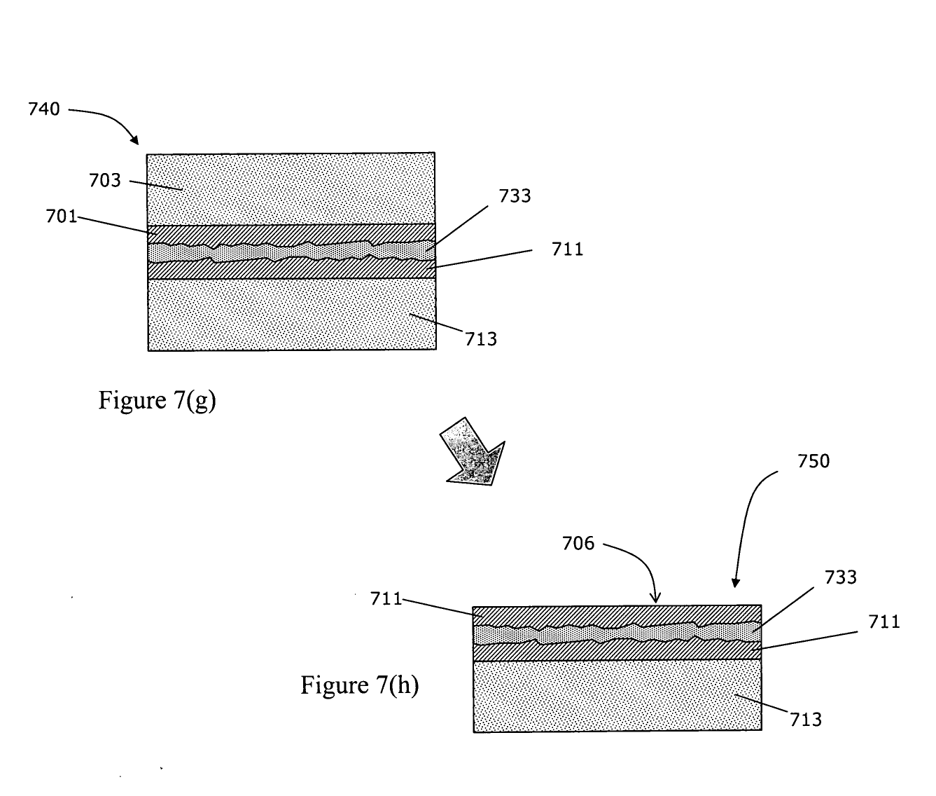

The third preferred method for manufacturing heat sinks with smooth and bow-free diamond films is explained with the help of FIG. 7 and process flow chart shown in FIG. 3(c). This method is based on bonding two diamond films with similar intrinsic stress in order to balance the bowing of the two films and realize a smooth and flat surface. Such films exert little or no stress on the underlying substrates.

The third preferred method starts with two silicon substrates 703 and 713 shown in FIGS. 7(a) and 7(b), respectively. The top surfaces 702 and 712 of the silicon wafers, 703 and 713, respectively, have specifications for flatness and bow desired by the specific application and described previously in the first and second preferred methods. In FIG. 7(c) a diamond film 701 is deposited onto the top surface 702 of silicon wafer 703, and in FIG. 7(d) a diamond film 711 is deposited onto the top surface 712 of silicon wafer 713. These diamond films (701 and 711) may be deposited at the same time, but may also be deposited independently at a different time. Each diamond film has its own thickness and inherent stress. The deposited diamond films 701 and 711 may have rough top surfaces 704 and 714, respectively. The surface of deposited diamond film 701 facing the substrate 703 is denoted with 706. The surface 706 conforms to the surface 702 and hence has similar surface roughness.

In FIG. 7(e) a bonding agent to form a bonding layer 722 is deposited on the diamond layer 701, and in FIG. 7(f) a bonding agent to form a bonding layer 732 is deposited on the diamond layer 711. In one embodiment, only one of the structures may have a bonding layer, namely, the bonding layer 732 is omitted from the process. The two structures shown in 720 and 730 are now joined by placing the bonding layer surfaces 722 and 732 in contact, as shown in FIG. 7(g), creating a composite structure 740. The bonding agent in the bonding layers 722 and 732 is subsequently activated to bond the two underlying diamond layers 711 and 721 together in step 740. The bonding layer 722 and bonding layer 732 from FIGS. 7(e) and FIG. 7(f) are now merged into a single bonding layer 733 in FIG. 7(g). In step 750, the substrate 703 is removed by either sandblasting and/or a chemical etch, leaving the underlying diamond film 701 undamaged. The resulting structure 750 shown in FIG. 7(h) exhibits a flat diamond layer mounted on a substrate. The revealed surface 706 of diamond layer 701 exhibits rms surface roughness less than 10 nm and bow less than 50 um over 300 mm. Additionally, the net bow due to stress of the structure 750 is close to zero as the stresses of the two diamond films are opposing and cancel each other.

The described third preferred method for bonding diamond layers may be used to stack more than two diamond layers by repeated application of a bonding layer and a diamond layer resulting in an alternating stack of diamond—bonding layer—diamond—bonding layer, etc., on top of a substrate. One of the purposes for this may be to further compensate the stress in this composite diamond film structure.

One of the advantages of third preferred method and the resulting structure shown in FIG. 7(h) is that defect propagation into silicon from the diamond surface is reduced in respect to the case where there are not strain-matching layers, because the diamond layers now do not have a residual stress. It is known that wafers with diamond films on them have a higher tendency to break because they are under stress and dislocations propagate through the silicon wafers due to the presence of the diamond film. Therefore, reducing the stress induced by the diamond film will reduce the dislocation propagation in the silicon films.

In the preceding description, numerous specific details are set forth in order to provide a thorough understanding of the present invention. It will be obvious, however, to one skilled in the art that the present invention may be practiced without these specific details. In other instances, well known aspects of CVD diamond growth and processing have not been described in particular detail in order to avoid unnecessarily obscuring the present invention. Additionally, films other than CVD diamond may take advantage of present invention in order to realize smooth surfaces. For example, gallium nitride, sapphire, silicon carbide, etc.

Generally, the diamond film on the silicon substrate is between 1 and 1000 micrometers thick and the roughness of the top surface is between 1 and 10 percent of the growth thickness.

It is clear from the disclosed preferred methods of manufacturing diamond heat spreading layers and heat sinks that the methods can be employed to create smooth layers of other materials that are heed in the electronic or optoelectronic industry, and that the uses of these layers are not limited to heat spreading or heat conduction. For example, diamond layers may be replaced with compound semiconductors, such as, gallium nitride, gallium arsenide, and other III-V or II-VI semiconductors that can be grown on silicon. A combination of particular interest is forming smooth gallium nitride layers as seed layers for optoelectronic device growth. Today, gallium nitride is being grown on less-than-ideal substrates, and providing free standing gallium nitride films or gallium nitride films mounted on an arbitrary substrate having surface roughness below 10 nm and very low bow offers great advantages for future optical and high-temperature electronic device development.

Furthermore, the silicon substrate material described in this disclosure may be replaced with any other available substrate material that is more appropriate for growth of any of the compound semiconductors.

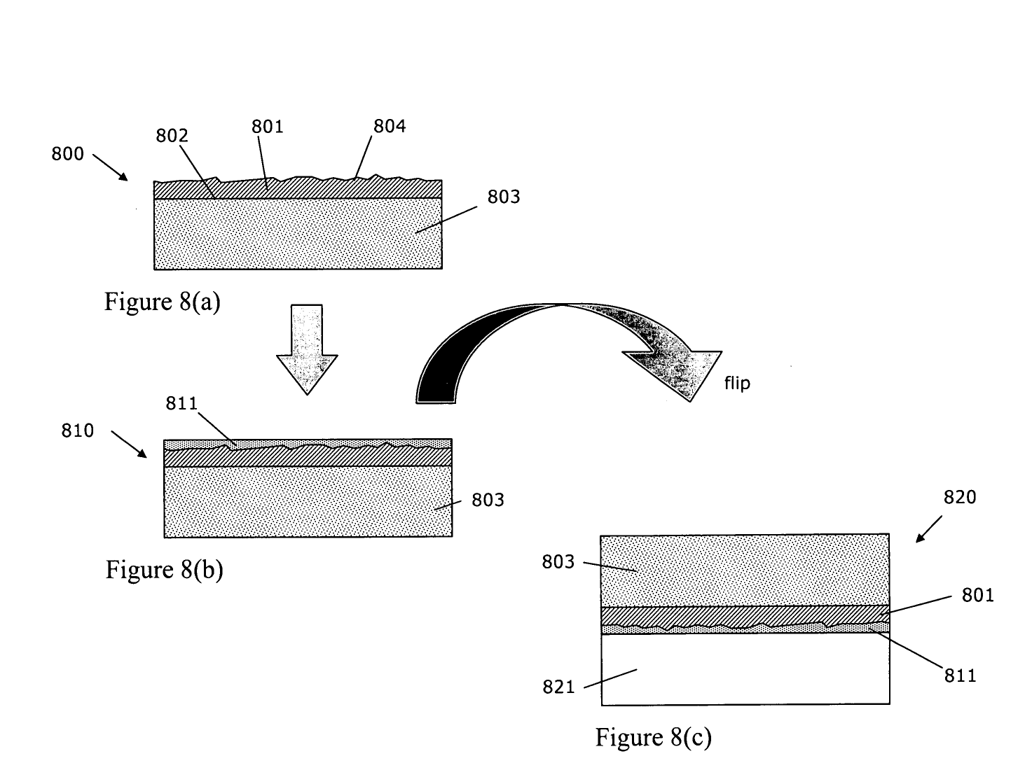

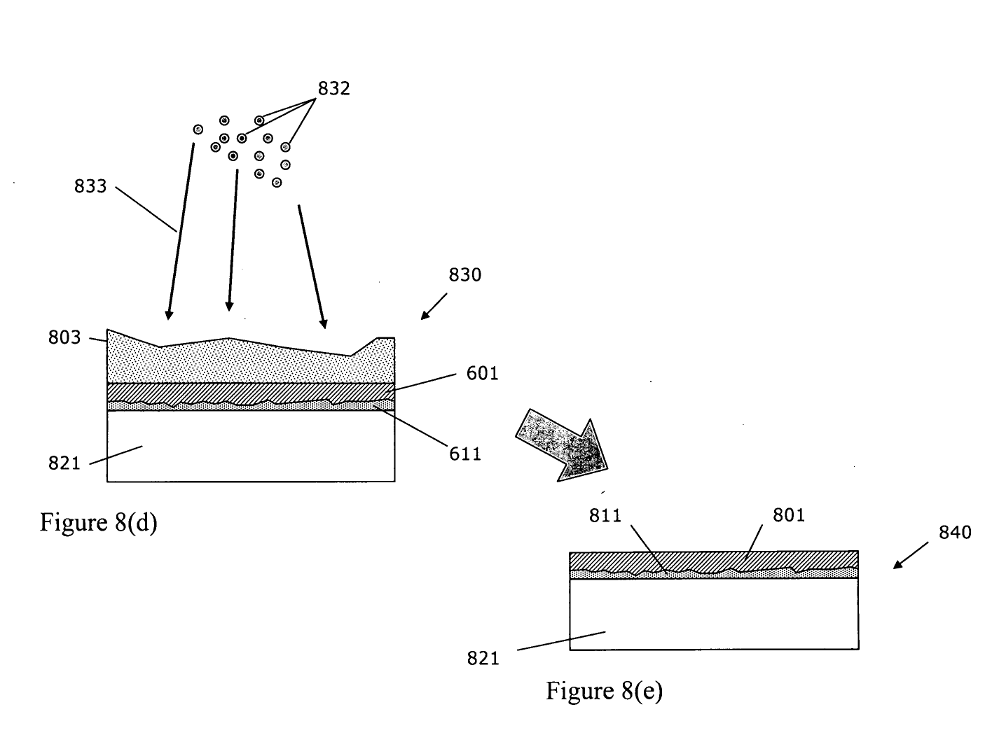

These generalizations are illustrated in FIGS. 8(a) through 8(e). In FIG. 8(a), a thin layer 801 of first material is deposited onto a first substrate 803. The top surface 802 of the first substrate 803 prior to the deposition of the thin layer 801 has been prepared to be smooth with the desired surface roughness specification. The top surface 804 of the thin layer 801 has roughness that is larger than that of the top surface 802 of the first substrate 803. In FIG. 8(b), a bonding layer 811 is deposited on top of the thin layer 801. In FIG. 8(c), the structure is flipped upside down and placed in contact with a second substrate 821 in such a way that the bonding layer 811 is in contact with the substrate 821. In FIG. 8(d), the first substrate is removed by sandblasting, chemical etch or polishing. FIG. 8(d) illustrates the embodiment in which the substrate 803 is removed by sandblasting with particles 832 in the direction shown with arrows 833. The entire substrate can be removed as shown in FIG. 8(e) where only the second substrate 821, the bonding layer 811, and the thin layer 801 remain. It is also possible to remove sections of the first substrate.

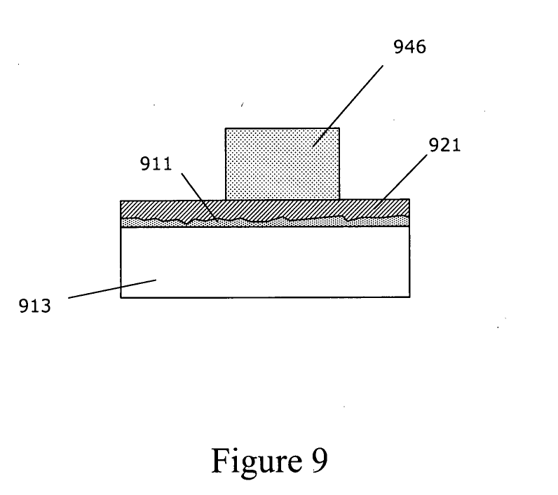

Finally, it is clear that one of the purposes of manufacturing a smooth and bow-free diamond heat sink is to enable placing an electronic or optical device on top of the smooth diamond surface. This is schematically illustrated in FIG. 9. A structure resulting from either first, second or third preferred methods described above exhibits a smooth diamond top layer 921 on top of at least one bonding layer 911, or optionally second or more diamond layers placed on top of a substrate 913. An electronic or optical device 946 is place in thermal contact with the diamond realizing a heat sink.

While certain representative embodiments and details have been shown for purposes of illustrating the invention, it will be apparent to those skilled in the art that various changes in the methods and apparatus disclosed herein may be made without departing from the scope of the invention which is defined in the appended claims.

What is claimed is:

1. A method for manufacturing a diamond film comprising the steps of:
(a) providing a first substrate having a top surface and a bottom surface;
(b) forming a diamond layer on the top surface of the substrate, the diamond layer having a first surface and a second surface, where the first surface of the diamond layer is adjacent to the top surface of the first substrate; and
(c) removing at least part of the first substrate to reveal the first surface of the diamond layer.

2. The method of claim 1, wherein the first surface of the diamond film has a room-mean-square surface roughness of less than 10 nanometers when measured over a square area on the diamond film with a size of not less than 10 micrometers on each side.

3. The method of claim 1, wherein the first substrate is silicon.

4. The method of claim 1, wherein the first substrate is gallium arsenide.

5. The method of claim 1, wherein the top surface of the first substrate has a room-mean-square surface roughness of less than 10 nanometers when measured over a square area on the first substrate with a size of not less than 10 micrometers on each side.

6. The method of claim 1, wherein the first substrate removal step includes sandblasting with particles.

7. The method of claim 6, wherein the particles include alumina particles.

8. The method of claim 1, wherein the first substrate removal step includes chemical etching.

9. A method for manufacturing a supported diamond film comprising the method of claim 1 and further comprising the steps of:
(a) after forming the diamond layer on the first substrate, forming a bonding layer on the second surface of the diamond layer, the bonding layer having a first surface and second surface, with the second surface of the bonding layer adjacent to the second surface of the diamond layer;
(b) providing a second substrate, the second substrate having a top surface and a bottom surface;
(c) placing the top surface of the second substrate in contact with the first surface of the bonding layer; and
(d) activating the bonding layer.

10. The method of claim 9, further comprising the steps of:
(a) providing a device chip, said device chip having at least one flat surface; and
(b) placing a flat surface of the device chip in contact with the first surface of the diamond layer.

11. The method of claim 9, further comprising the steps of:
(a) providing at least one device chip; and
(b) placing the device chip in thermal contact with the first surface of the diamond layer.

12. The method of claim 10, wherein the device chip is a semiconductor laser.

13. The method of claim 11, wherein the device chip is a semiconductor laser.

14. The method of claim 10, wherein the device chip is an electronic integrated circuit.

15. The method of claim 11, wherein the device chip is an integrated circuit.

16. The method of claim 1, further comprising the steps of:
(a) after forming the diamond layer on the first substrate, forming a first bonding layer on the second surface of the diamond layer, the first bonding layer having a first surface and second surface, with the second surface of the first bonding layer adjacent to the second surface of the diamond layer;
(b) providing a second substrate having a top surface and a bottom surface;
(c) forming a second diamond layer on the top surface of the second substrate, the second diamond layer having a first surface and a second surface, where the first surface of the second diamond layer is adjacent to the top surface of the second substrate;
(d) forming a second bonding layer on the surface of the second diamond layer, the second bonding layer having a first surface and second surface, with the second surface of the second bonding layer adjacent to the second surface of the second diamond layer;
(e) placing the first surface of the first bonding layer in contact with the first surface of second bonding layer; and
(f) activating the first bonding layer and the second bonding layer.

17. The method of claim 16, wherein the first substrate is silicon.

18. The method of claim 17, wherein the first substrate removal includes sandblasting with particles.

19. A method for manufacturing of a diamond film comprising the steps of:
(a) providing a first substrate having a top surface and a bottom surface;
(b) forming a first diamond layer on the top surface of the first substrate, the diamond layer having a first surface and a second surface, where the second surface of the first diamond layer is adjacent to the top surface of the first substrate;
(c) forming a bonding layer on the first surface of the first diamond layer, the bonding layer having a first surface and second surface, with the second surface of the bonding layer adjacent to the first surface of the first diamond layer;
(d) providing a second substrate having a top surface and a bottom surface;
(e) forming a second diamond layer on the top surface of the second substrate, the diamond layer having a first surface and a second surface, where the second surface of the second diamond layer is adjacent to the top surface of the second substrate;
(f) placing the first surface of the bonding layer in contact with the first surface of the second diamond layer;
(g) activating the bonding layer; and
(h) removing at least part of the first substrate to reveal the second surface of the first diamond layer.

20. The method of claim 16, wherein the first bonding layer is a material selected from the group consisting of polysilicon, silicon dioxide, silicon nitride, spin-on glass, aluminum nitride, tin oxide, photoresist, wax, glue, gold, tin, gold-tin, titanium, chromium, platinum, aluminum, copper, aluminum, lead, indium, nickel, and silver.

21. The method of claim 17, wherein the first substrate is single crystal silicon.

22. The method of claim 19, wherein the first substrate is single crystal silicon.

23. The method of claim 16, wherein the material of the second substrate is selected from the group consisting of copper, steel, silver, gold, silicon dioxide, silicon nitride, quartz, sapphire, silicon, and silicon carbide.

24. The method of claim 19, wherein the material of the second substrate is selected from the group consisting of copper, steel, silver, gold, silicon dioxide, silicon nitride, quartz, sapphire, silicon, and silicon carbide.

25. The method of claim 16, wherein the first substrate is completely removed.

26. The method of claim 19, wherein the first substrate is completely removed.

27. The method of claim 16, wherein at least part of the first substrate is removed to reveal an area having a substantially circular shape.

28. The method of claim 19, wherein at least part of the first substrate is removed to reveal an area having a substantially circular shape.

29. The method of claim 16, wherein at least part of the first substrate is removed to reveal an area having a substantially oval shape.

30. The method of claim 19, wherein at least part of first substrate is removed to reveal an area having a substantially oval shape.

31. The method of claim 16, wherein the second bonding layer is selected from the group consisting of polysilicon, silicon dioxide, silicon nitride, spin-on glass, aluminum nitride, tin oxide, photoresist, wax, glue, gold, tin, gold-tin, titanium, chromium, platinum, aluminum, copper, aluminum, lead, indium, nickel, and silver.

32. The method of claim 9, wherein the bonding layer is selected from the group consisting of polysilicon, silicon dioxide, silicon nitride, spin-on glass, aluminum nitride, tin oxide, photoresist, wax, glue, gold, tin, gold-tin, titanium, chromium, platinum, aluminum, copper, aluminum, lead, indium, nickel, and silver.
